(19) United States
(12) Patent Application Publication
(10) Pub. No.: US 2022/0211189 A1
(43) Pub. Date: Jul. 7, 2022

(54) BARRIER FOR MATTRESS AND BED DECK

(71) Applicant: Trinity Guardion, LLC, Batesville, IN (US)

(72) Inventors: David John Ulrich, Sunman, IN (US); Bruce M. Rippe, Batesville, IN (US)

(21) Appl. No.: 17/705,281

(22) Filed: Mar. 26, 2022

Related U.S. Application Data
(63) Continuation of application No. 16/811,095, filed on Mar. 6, 2020, now Pat. No. 11,284,726.

(51) Int. Cl. A47C 31/10; A47C 27/00; A47C 21/02

(52) U.S. Cl. CPC A47C 31/105; A47G 9/04; A47C 21/022; A47C 27/008

(57) ABSTRACT

A barrier for a mattress and a bed deck is provided. The barrier includes a mattress cover portion and a skirt. The mattress cover portion is configured to fit over a top and sides of a mattress. The skirt extends beneath the mattress cover portion. The skirt comprises an upper panel and a lower panel. The upper panel is coupled with the mattress cover portion. The lower panel is coupled with the upper panel. The lower panel comprises a lower edge. The lower panel is configured for selective coupling to a bed deck.

### REFERENCE TO RELATED APPLICATION

This application is a continuation of U.S. patent application Ser. No. 16/811,095, filed Mar. 6, 2020, entitled Barrier for Mattress and Bed Deck which claims priority of U.S. provisional Patent App. Ser. No. 62/815,662, entitled Barrier for Mattress and Bed Deck, filed Mar. 8, 2019, and hereby incorporates each of these patent applications by reference herein in their respective entireties.

### TECHNICAL FIELD

The apparatus and methods disclosed herein relate to a barrier for a mattress and bed deck. More particularly, the apparatus and methods relate to a mattress and bed deck barrier for an adjustable bed that reduces the exposure of the mattress and bed deck to unsanitary conditions.

### BACKGROUND

Healthcare mattresses have integrated covers that enclose the mattress components and are designed to protect the internal mattress components from staining, soiling, bodily fluids, and infectious microorganisms. Mattress covers must be cleaned and disinfected between each patient use to maintain a sanitary environment for the patient. Most integrated covers are inherently difficult to clean and disinfect. They may not be removable, or if so, are not designed for regular removal. Thus, they are intended for cleaning by manual wiping, which requires a substantial amount of time, effort, and consistency to achieve adequate disinfection. Many integrated covers have exposed woven fabric, which further diminishes the potential for effective disinfection. Zippers are usually used to attach integrated mattress covers and if the flap covering the zipper is displaced by bed linens, the zippers will permit bodily fluids to enter the mattress. These covers may also have sewn seams where each stitch hole is a location for bodily fluids to enter the mattress. Finally, integrated covers are prone to failure and fluid leakage due to use of strong chemicals required to achieve disinfection. Failures are difficult to detect before fluid leakage occurs and require time consuming inspection between each patient use. A barrier between the mattress and patient that eliminates all aforementioned issues and provides a highly disinfected and intact resting surface for the patient is desirable.

Mattresses are supported by bed decks. Bed decks come into contact with the same unsanitary conditions as mattresses. For example, waste produced by a patient may flow off the mattress or mattress barrier and accumulate on the supporting bed deck. Under current techniques, the mattress must be manually raised from the bed deck, the bed deck cleaned by hand using a germicidal solution, and the mattress replaced atop the bed deck which can be cumbersome and time consuming. However, hospital workers may neglect to clean the bed deck, or may not fully clean the entire surface of the bed deck. Furthermore, manual cleaning may not be sufficient to eliminate bacteria embedded in the bed deck or to kill fungal spores. Any remaining contamination may be passed from the bed deck to the mattress or bed sheets, from which the contaminants may contact a patient.

### BRIEF DESCRIPTION OF THE DRAWINGS

Various embodiments will become better understood with regard to the following description, appended claims and accompanying drawings wherein:

FIG. 1 is an exploded side view depicting a barrier in association with a mattress and an adjustable bed;

FIG. 2 is an assembled side view depicting the barrier, the mattress, and the adjustable bed of FIG. 1;

FIG. 3 is an enlarged view depicting a button attached to the adjustable bed of FIG. 1;

FIG. 4 is a bottom elevational view of the barrier of FIG. 1;

FIG. 5 is an enlarged side view depicting the barrier, the mattress, and the adjustable bed barrier of FIG. 2, but with the mattress shown in a tilted position;

FIG. 6 is a front elevational view of the barrier of FIG. 1;

FIG. 7 is an enlarged elevational view of a front corner of the barrier of FIG. 1;

FIG. 8 is a rear elevational view of the barrier of FIG. 1; and

FIG. 9 is an enlarged elevational view of a rear corner of the barrier of FIG. 1.

### DETAILED DESCRIPTION

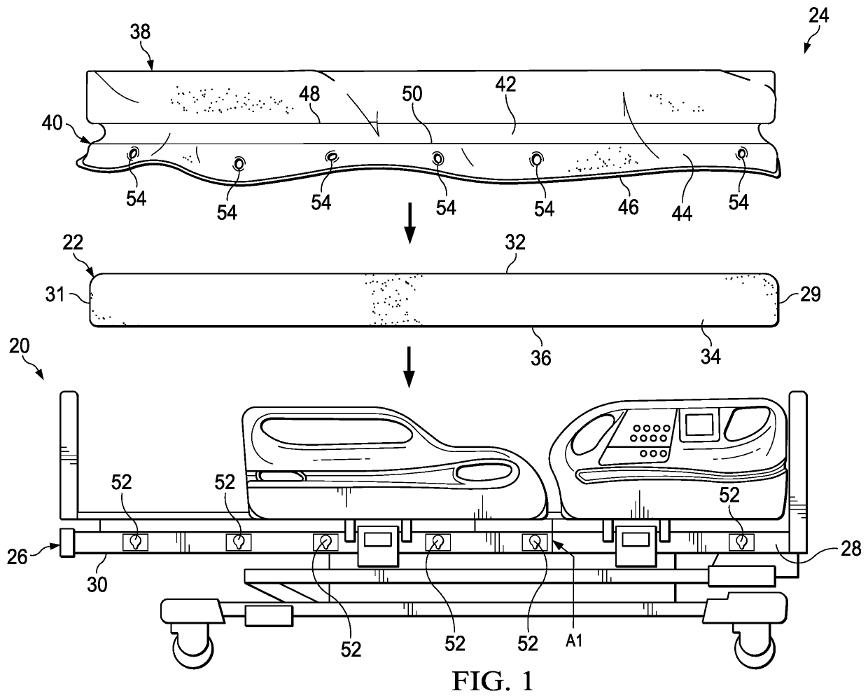

Embodiments are hereinafter described in detail in connection with the views and examples of FIGS. 1-9, wherein like numbers indicate the same or corresponding elements throughout the views. An adjustable bed 20, a mattress 22, and a combination mattress/bed deck barrier 24 (hereinafter “the barrier”) are generally depicted in FIG. 1. The adjustable bed 20 can include a bed deck 26 that includes a front frame portion 28 and a rear frame portion 30. The front and rear frame portions 28, 30 can support and underlie a head end 29 and a foot end 31, respectively, of the mattress 22. The front frame portion 28 can be pivotable (e.g., vertically) with respect to the rear frame portion 30 about an axis A1 to allow for selective vertical adjustment of the head end 29 of the mattress 22 relative to the foot end 31 (e.g., to facilitate adjustment of a user's head relative to their feet).

The mattress 22 can include a top 32, a plurality of sides 34, and a bottom 36. The barrier 24 can include a mattress cover portion 38 and a skirt 40 that extends beneath the mattress cover portion 38. The skirt 40 can include an upper panel 42 and a lower panel 44. The lower panel 44 can include a lower edge 46. The upper panel 42 can be coupled with the mattress cover portion 38 along a perimeter P1 of the barrier 24 and the lower panel 44 can be coupled with the upper panel 42 along a perimeter P2 of the barrier 24. In one embodiment, the mattress cover portion 38 and the upper panel 42 can be attached together (e.g., sewn, bonded or welded) along a longitudinal seam 48 that defines the perimeter P1, and the upper panel 42 and the lower panel 44 can be attached together (e.g., sewn, bonded or welded) along a longitudinal seam 50 that defines the perimeter P2. In another embodiment, the mattress cover portion 38, the upper panel 42, and the lower panel 44 can be formed together as a one-piece construction such that the perimeter P1 is defined by the transition between the mattress cover portion 38 and the upper panel 42 and the perimeter P2 is defined by the transition between the upper panel 42 and the lower panel 44.

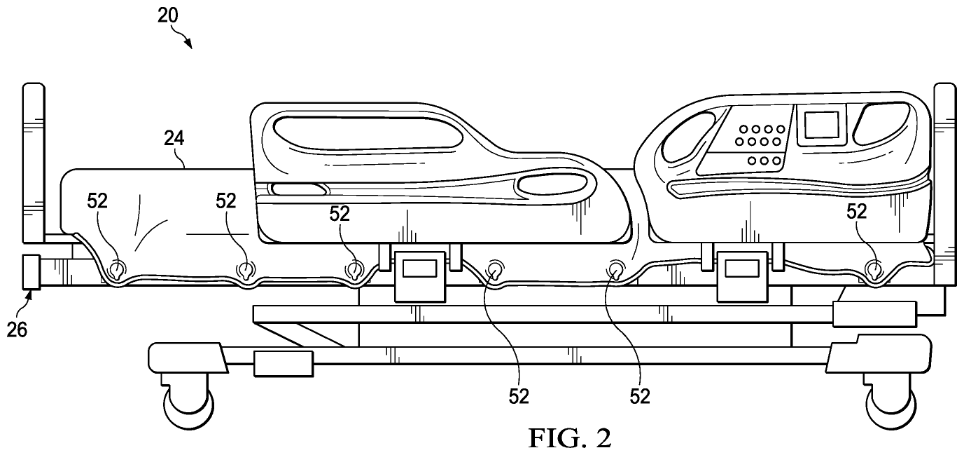

Referring now to FIGS. 1 and 2, when the barrier 24 is installed on the mattress 22 (FIG. 2), the mattress cover portion 38 can fit over the top 32 and sides 34 of the mattress 22 and the skirt 40 can extend beneath the mattress 22. The lower panel 44 of the skirt 40 can extend to the bed deck 26 and can be coupled thereto by a plurality of buttons 52 (FIG. 1) that are provided through respective apertures 54 (e.g., FIG. 1) that are disposed along the lower edge 46 of the lower panel 44.

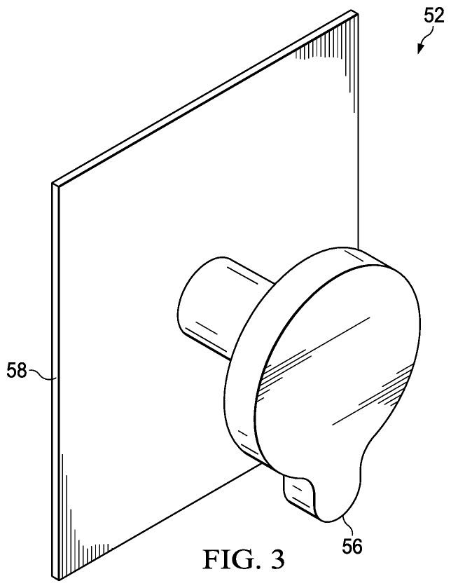

Referring now to FIG. 3, one of the buttons 52 is illustrated as a representative example of each of the buttons 52 illustrated in FIGS. 1 and 2. The button 52 can include a tip portion 56 that extends downwardly such that the button 52 has an inverted teardrop shape. When the button 52 is inserted into one of the apertures 54, the tip portion 56 can interface with the lower panel 44 to prevent the lower panel 44 from being inadvertently disconnected from the button 52. The button 52 can be attached to the bed deck 26 by an adhesive layer 58. In one embodiment, the adhesive layer 58 can be a “peel and stick” adhesive layer such that the button 52 can be selectively attached to the bed deck 26 to enable retrofitting of the barrier 24 to an existing adjustable bed. It is to be appreciated that, although a plurality of buttons 52 are described, any of a variety of suitable alternative attachment members are contemplated for selectively attaching the lower panel 44 to the bed deck 26, such as, for example, hooks, snaps, threaded fasteners, magnets, and hook and loop attachments. It is also to be appreciated that the lower panel 44 can have a variety of suitable alternative configurations that facilitate attachment of the lower panel 44 to a bed deck (e.g., 26).

When the barrier 24 is installed over the mattress 22 and attached to the bed deck 26 (e.g., via the buttons 52), as illustrated in FIG. 2, the barrier 24 can extend over each of the mattress 22, the area beneath the mattress 22, and the bed deck 26 to provide a continuous barrier therebetween. When the front frame portion 28 is pivoted (e.g., about axis A1), the barrier 24 can move together with the mattress 22 and the front frame portion 28 to maintain effective coverage over the mattress 22 and the bed deck 26. When the front frame portion 28 is pivoted upwardly, the mattress cover portion 38 can be configured to accommodate any sliding of the foot end 31 of the mattress 22 beyond the rear frame portion 30 to prevent the barrier 24 from being inadvertently dislodged from the mattress 22 and/or the bed deck 26. The barrier 24 therefore can provide more thorough and consistent coverage over a mattress and bed frame than conventional mattress covers (e.g., retail mattress covers that are only configured to cover a mattress).

It is to be appreciated that when the barrier 24 needs to be replaced (e.g., when it is dirty), the skirt 40 can first be detached from the bed deck 26 by manually disengaging the buttons 52 from the apertures 54 and the mattress cover portion 38 can then be slid off of the mattress 22 to completely remove the barrier 24 from the mattress 22. A clean barrier (e.g., 24) can then be installed by simply slipping the mattress cover portion 38 over the mattress 22 and attaching the skirt 40 to the buttons 52. The construction of the barrier 24 and the buttons 52 cooperate to enable easier and less cumbersome removal and installation than conventional mattress covers.

The barrier 24 can be formed of an impermeable material (e.g., the barrier material) that withstands hydrostatic pressure, can prevent penetration by microorganisms in accordance with medical device barrier standards, and meets biocompatibility requirements for limited contact with human skin. When the barrier 24 is installed on the mattress 22 and attached to the bed deck 26, as illustrated in FIG. 2, the mattress cover portion 38 and the skirt 40 can cooperate to prevent the mattress 22 and the area beneath the mattress 22 from being exposed to any contaminants that may be present on the barrier 24, such as bodily fluids, infectious microorganisms, and dirt. The barrier 24 can accordingly provide a more effective and comprehensive bed barrier solution.

In one embodiment, the barrier material can comprise a multi-directional stretch polyester fabric with welded or sealed seams and/or corners. The barrier material can be coated with a film coating that enhances the disinfecting properties of the barrier 24. In one embodiment, the film coating can be a polyurethane and can incorporate an antimicrobial and/or antifungal agent such as, for example, antimicrobial metal or borophosphosilicate glass carriers containing silver ions. In some embodiments, the film coating can have non-leaching properties. The barrier material can also include flame retardants and thus can be resistant to burning. The barrier material can also be configured to define various multi-directional stretch characteristics that permit the mattress 22 to distribute the patient load as intended without causing the barrier 24 to tear or fail. The barrier material can be configured to provide some level of moisture vapor transfer such that microclimate management features incorporated in some healthcare mattresses are still able to reach the patient.

The barrier material can be configured to withstand conventional healthcare laundering techniques, such as, for example, a process with chemicals and temperatures that provide a 99.9999% reduction (log 6) in common pathogenic microorganisms. As such, the barrier 24 can be repeatedly washed and reused which can be more cost effective and less wasteful than certain conventional mattress covers.

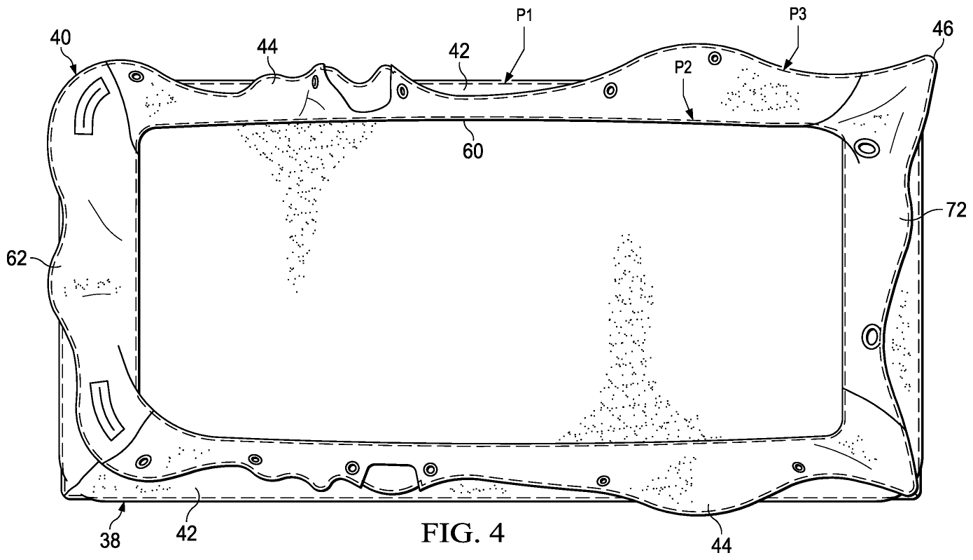

Referring now to FIG. 4, the perimeter P2 that is at least partially defined by the intersection of the upper panel 42 and the lower panel 44 can be smaller than the perimeter P1 that is at least partially defined by the intersection of the mattress cover portion 38 and the upper panel 42. The perimeter P2 can be smaller than a perimeter P3 that is defined by the lower edge 46 of the lower panel 44. As a result, when the barrier 24 is installed on the mattress 22 and bed deck 26, the skirt 40 can be gathered under the mattress 22 while also extending to the bed deck 26. In one embodiment, as illustrated in FIG. 4, the barrier 24 can include an elastic band 60 that is routed along the perimeter P2. The elastic band 60 can facilitate drawing or cinching of the skirt 40 under the mattress 22 such that at least a portion of the skirt 40 is provided between the mattress 22 and the bed deck 26. In another embodiment, the barrier 24 can include a drawstring or other feature that facilitates selective collection (e.g., drawing) of the barrier 24 under the mattress 22.

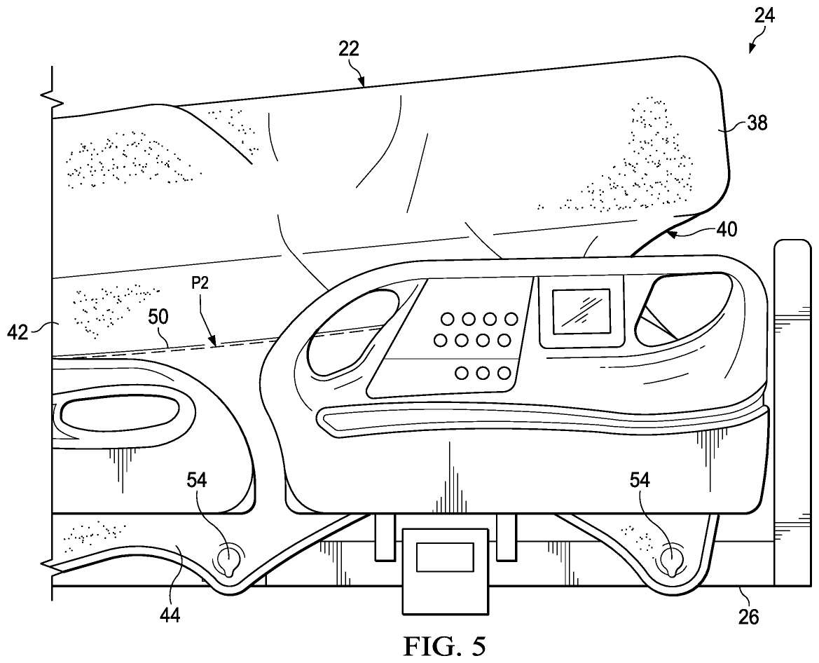

Referring now to FIGS. 2 and 5, the mattress 22 can be selectively tilted relative to the bed deck 26 between a flat position (FIG. 2) and a tilted position (FIG. 5). As illustrated in FIG. 5, when the mattress 22 is in the tilted position, one side of the mattress 22 (e.g., a left side) can be elevated relative to the bed deck 26 which can aid a caregiver in positioning or turning a patient. It is to be appreciated that although FIG. 5 shows only the head end 29 of the mattress 22 elevated, the foot end (e.g., 31) can be additionally or alternatively elevated during tilting of the mattress 22. When the mattress 22 is tilted, the skirt 40 can be laterally expanded to accommodate such tilting while remaining attached to the bed deck 26 to prevent contaminants from being introduced underneath the mattress 22 and along the bed deck 26 during such tilting. It is to be appreciated that the upper panel 42 and the lower panel 44 can include enough excess material to allow the barrier 24 to be gathered under the mattress 22 when flat (as illustrated in FIG. 2), as well as to accommodate tilting of the mattress 22 (as illustrated in FIG. 5).

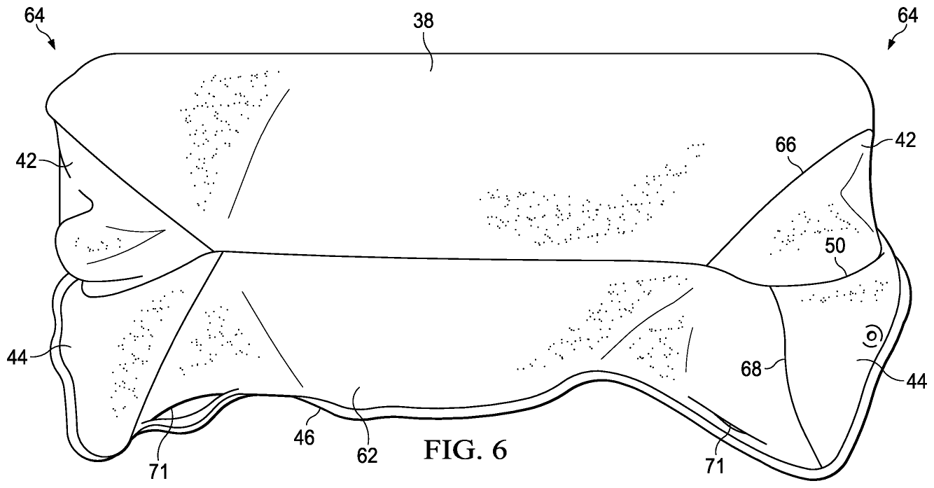

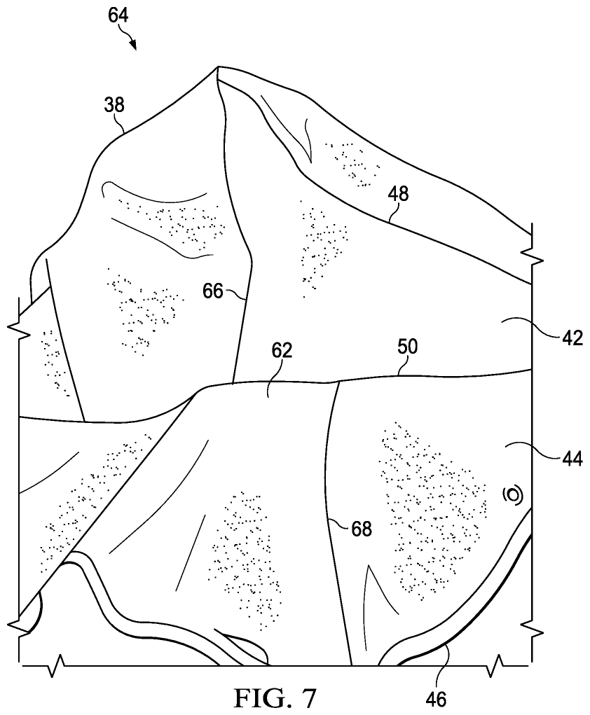

Referring now to FIGS. 6 and 7, the skirt 40 can include a front panel portion 62 that is joined together with the upper and lower panels 42, 44 at front corners 64. One of the front corners 64 is illustrated in FIG. 7 and can be understood to be representative of both of the front corners 64. The upper panel 42 can be coupled with the mattress cover portion 38 along a lateral seam 66 that extends laterally from the longitudinal seam 48 (e.g., from the perimeter P1).

The lower panel 44 can be coupled with the front panel portion 62 along a lateral seam 68 that extends laterally from the longitudinal seam 50 (e.g., from the perimeter P2) to the lower edge 46. The lateral seams 66, 68 can be laterally offset from each other along the longitudinal seam 50 (e.g., spaced from each other) such that a portion of the longitudinal seam 50 extends between the lateral seams 66, 68 (e.g., the lateral seams 66, 68 are not collinear). This arrangement of the seams 50, 66, 68 can be stronger and less prone to failure than the conventional X-shaped or T-shaped seams that are commonly found in conventional bed barrier arrangements. The barrier 24 can also include an inlet port 71 that allows for routing of a mattress component or accessory through the barrier 24 (e.g., an air hose when the mattress 22 is inflatable or a strap used to activate a CPR function within the mattress 22).

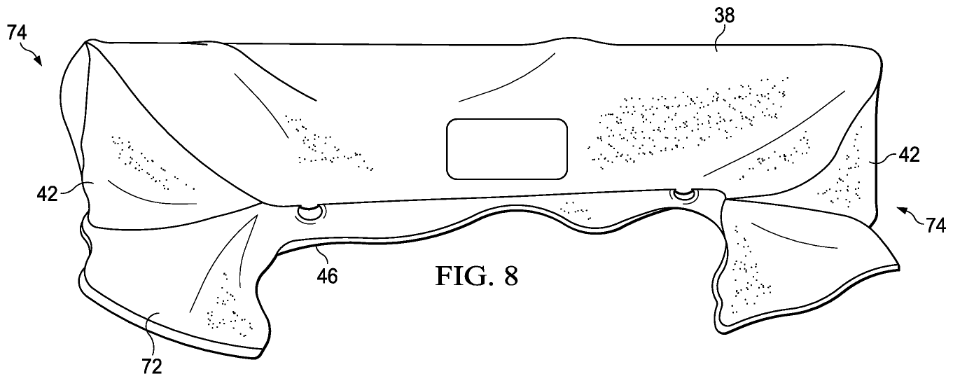

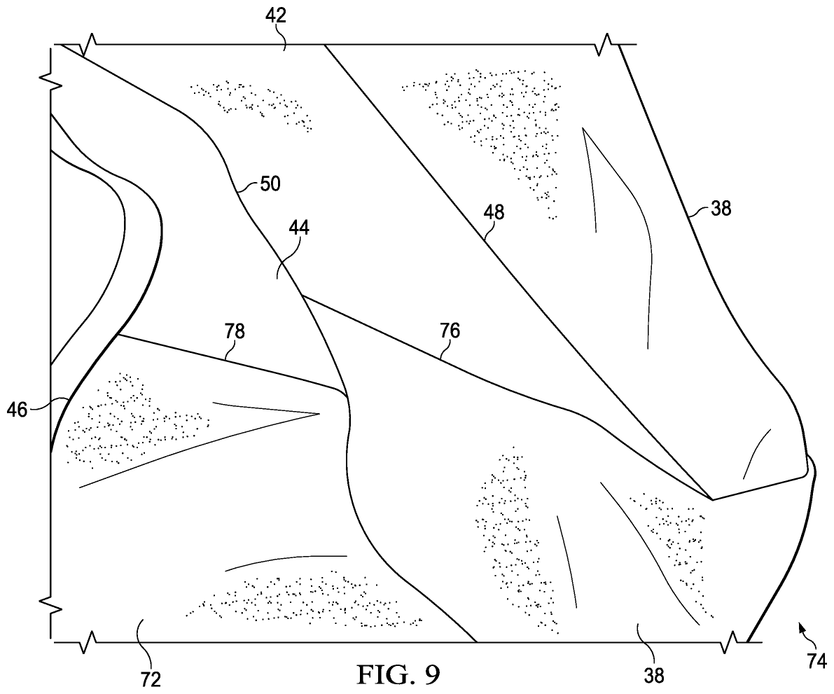

Referring now to FIGS. 8 and 9, the skirt 40 can include a rear panel portion 72 that is joined together with the upper and lower panels 42, 44 at rear corners 74. One of the rear corners 74 is illustrated in FIG. 9 and can be understood to be representative of both of the rear corners 74. The upper panel 42 can be coupled with the mattress cover portion 38 along a lateral seam 76 that extends laterally from the longitudinal seam 48 (e.g., from the perimeter P1). The lower panel 44 can be coupled with the rear panel portion 72 along a lateral seam 78 that extends laterally from the longitudinal seam 50 (e.g., from the perimeter P2) to the lower edge 46. The lateral seams 76, 78 can be laterally offset from each other along the longitudinal seam 50 (e.g., spaced from each other) such that a portion of the longitudinal seam 50 extends between the lateral seams 76, 78 (e.g., the lateral seams 76, 78 are not collinear). This arrangement of the seams 50, 66, 68 can be stronger and less prone to failure than the conventional X-shaped or T-shaped seams that are commonly found in conventional bed barrier arrangements.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A barrier for a mattress and a bed deck, the barrier comprising:
a mattress cover portion configured to fit over a top and sides of a mattress; and
a skirt extending beneath the mattress cover portion and coupled with the mattress cover portion, the skirt comprising:
an upper panel coupled with the mattress cover portion;
a lower panel coupled with the upper panel;
a front panel portion coupled with the mattress cover portion; and
a rear panel portion coupled with the mattress cover portion, wherein:
the front panel portion and the rear panel portion are each coupled with the lower panel;
the lower panel, the front panel portion, and the rear panel portion cooperate to form a lower edge;
the lower panel, the front panel portion, and the rear panel portion cooperate to form a continuous panel; and
the lower panel is configured for selective coupling to a bed deck.

2. The barrier of claim 1 further comprising an elastic band disposed that is configured to gather the skirt between the mattress cover portion and the lower edge.

3. The barrier of claim 1 wherein the lower panel is coupled with the upper panel along a seam.

4. The barrier of claim 1 wherein:
the upper panel is directly attached to the mattress cover portion along a first seam;
the lower panel is directly attached to the front panel portion along a second seam; and
the first seam and the second seam are laterally offset from one another.

5. The barrier of claim 1 wherein the lower panel defines a plurality of apertures configured to receive fasteners to facilitate selective coupling of the lower panel to a bed deck.

6. The barrier of claim 1 wherein the barrier is formed of an impermeable material.

7. The barrier of claim 6 wherein the impermeable material comprises a multi-directional stretch polyester fabric.

8. The barrier of claim 1 wherein the barrier comprises a film coating.

9. The barrier of claim 8 wherein the film coating comprises polyurethane.

10. The barrier of claim 9 wherein the film coating comprises one or more of an antimicrobial agent and an antifungal agent.

11. The barrier of claim 10 wherein the antimicrobial agent comprises borosilicate glass particles doped with silver ions.

12. The barrier of claim 1 wherein:
the upper panel is directly attached to the mattress cover portion along a first seam;
the lower panel is directly attached to the rear panel portion along a second seam; and
the first seam and the second seam are laterally offset from one another.

13. A kit comprising:
a barrier for a mattress and a bed deck, the barrier comprising:
a mattress cover portion configured to fit over a top and sides of a mattress; and
a skirt extending beneath the mattress cover portion and coupled with the mattress cover portion, the skirt comprising:
an upper panel coupled with the mattress cover portion;
a lower panel coupled with the upper panel;
a front panel portion coupled the mattress cover portion; and
a rear panel portion coupled with the mattress cover portion; and
a plurality of attachment members configured to facilitate selective attachment of the skirt to a bed deck of a bed deck, wherein:
the front panel portion and the rear panel portion are each coupled with the lower panel;
the lower panel, the front panel portion, and the rear panel portion cooperate to form a lower edge;
the lower panel, the front panel portion, and the rear panel portion cooperate to form a continuous panel; and
the lower panel is configured for selective coupling to a bed deck.

14. The kit of claim 13 wherein the plurality of attachment members comprise a plurality of buttons configured for attachment to a bed deck, and the skirt defines a plurality of apertures that are each configured to interface with respective ones of the plurality of buttons to facilitate selective attachment of the skirt to a bed deck.

15. The kit of claim 14 wherein each button of the plurality of buttons comprises an adhesive layer to facilitate attachment of the button to a bed deck.

16. The kit of claim 13 wherein the barrier is formed of an impermeable material.

17. The barrier of claim 16 wherein the barrier comprises a film coating that comprises one or more of an antimicrobial agent and an antifungal agent.

18. A barrier for a mattress and a bed deck, the barrier comprising:
a mattress cover portion configured to fit over a top and sides of a mattress; and
a skirt extending beneath the mattress cover portion and coupled with the mattress cover portion, the skirt comprising:
an upper panel coupled with the mattress cover portion;
a lower panel coupled with the upper panel; and
a front panel portion coupled with the mattress cover portion, wherein:
the lower panel is configured for selective coupling to a bed deck;
the lower panel and the front panel portion cooperate to form a lower edge;
the upper panel is directly attached to the mattress cover portion along a first seam;
the lower panel is directly attached to the front panel portion along a second seam; and
the first seam and the second seam are laterally offset from one another.

19. The barrier of claim 18 wherein the barrier is formed of an impermeable material.

20. The barrier of claim 19 wherein the barrier comprises a film coating that comprises one or more of an antimicrobial agent and an antifungal agent.
